(19) United States
(12) Patent Application Publication
(10) Pub. No.: US 2023/0229944 A1
(43) Pub. Date: Jul. 20, 2023

(54) AUTO-ENRICHING CLIMATE-AWARE SUPPLY CHAIN MANAGEMENT

(71) Applicant: International Business Machines Corporation, Armonk, NY (US)

(72) Inventors: Fred Ochieng Otieno, Nairobi (KE); Smitkumar Narotambhai Marvaniya, BANGALORE (IN); Reginald Eugene Bryant, Naiorbi (KE); Komminist Weldemariam, Ottawa (CA)

(21) Appl. No.: 17/566,647

(22) Filed: Dec. 30, 2021

(51) Int. Cl. G06N 5/04; G06N 5/02; G06Q 10/08; G06N 3/04

(52) U.S. Cl. CPC G06N 5/045; G06N 3/0454; G06N 5/02; G06Q 10/08

(57) ABSTRACT

User interactions with a supply chain system are monitored based on a tracked ontology enrichment process, an explainable reasoning graph is constructed based on the monitored user interactions and domain specific reasoning information; and an explainable insight of the monitored user interactions is learned, as is a user interaction embedding for an embedding space, based on the constructed explainable reasoning graph and the explainable insight. External data is incorporated into the embedding space, a joint embedding is learned based on the user interaction embedding, and missing entities and relationships are identified for incorporation into an ontology based on the user interactions and joint embedding. The ontology is revised to incorporate the missing entities and relationships into the ontology to create a revised ontology, and a supply chain is controlled based on the revised ontology.

### BACKGROUND

The present invention relates to the electrical, electronic and computer arts, and more specifically, to techniques for controlling and managing a supply chain.

Supply chain operations are designed to be optimized and to be resilient against various events in supply, demand, or both. Artificial Intelligence (AI) / Machine Learning (ML) models are used to analyze some of these operations and also to explain why a certain recommendation is being made. Among other factors, supply chain resiliency is largely dependent on the accuracy of the ML/AI models as used for various tasks, such as demand forecasting, lead-time forecasting, and the like. Data or insights from these forecasts are in turn used for inventory optimization. It is pertinent to identify errors in weather/climate forecasts, errors in demand predictions due to weather/climate forecasts, errors in resiliency policy generation, errors due to the underlying AI/ML model prediction errors, and the like. Various data sources, such as climate forecasts, risk of disruptive events, and the like, are appropriately analyzed and correlated with models (in an explainable way) in order to analyze and control supply chain operations. These often require the retraining of AI/ML models to enable continuous model enrichment.

### SUMMARY

Principles of the invention provide techniques for auto-enriching climate-aware supply chain control and management (for example, for auto-enriching a domain specific ontology for climate-aware supply chain control and management). In one aspect, an exemplary method includes the operations of monitoring user interactions with a supply chain system based on a tracked ontology enrichment process; constructing an explainable reasoning graph based on the monitored user interactions and domain specific reasoning information; learning an explainable insight of the monitored user interactions; learning a user interaction embedding for an embedding space based on the constructed explainable reasoning graph and the explainable insight; incorporating external data into the embedding space; learning a joint embedding based on the user interaction embedding; identifying missing entities and relationships for incorporation into an ontology based on the user interactions and joint embedding; revising the ontology to incorporate the missing entities and relationships into the ontology to create a revised ontology; and controlling a supply chain based on the revised ontology

In one aspect, an apparatus comprises a memory and at least one processor, coupled to the memory, and operative to perform operations comprising monitoring user interactions with a supply chain system based on a tracked ontology enrichment process; constructing an explainable reasoning graph based on the monitored user interactions and domain specific reasoning information; learning an explainable insight of the monitored user interactions; learning a user interaction embedding for an embedding space based on the constructed explainable reasoning graph and the explainable insight; incorporating external data into the embedding space; learning a joint embedding based on the user interaction embedding; identifying missing entities and relationships for incorporation into an ontology based on the user interactions and joint embedding; revising the ontology to incorporate the missing entities and relationships into the ontology to create a revised ontology; and controlling a supply chain based on the revised ontology.

In one aspect, a computer program product comprises a computer readable storage medium having program instructions embodied therewith, the program instructions executable by a computer to cause the computer to perform operations comprising monitoring user interactions with a supply chain system based on a tracked ontology enrichment process; constructing an explainable reasoning graph based on the monitored user interactions and domain specific reasoning information; learning an explainable insight of the monitored user interactions; learning a user interaction embedding for an embedding space based on the constructed explainable reasoning graph and the explainable insight; incorporating external data into the embedding space; learning a joint embedding based on the user interaction embedding; identifying missing entities and relationships for incorporation into an ontology based on the user interactions and joint embedding; revising the ontology to incorporate the missing entities and relationships into the ontology to create a revised ontology; and controlling a supply chain based on the revised ontology.

As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed. For the avoidance of doubt, where an actor facilitates an action by other than performing the action, the action is nevertheless performed by some entity or combination of entities.

One or more embodiments of the invention or elements thereof can be implemented in the form of a computer program product including a computer readable storage medium with computer usable program code for performing the method steps indicated. Furthermore, one or more embodiments of the invention or elements thereof can be implemented in the form of a system (or apparatus) including a memory, and at least one processor that is coupled to the memory and operative to perform exemplary method steps. Yet further, in another aspect, one or more embodiments of the invention or elements thereof can be implemented in the form of means for carrying out one or more of the method steps described herein; the means can include (i) hardware module(s), (ii) software module(s) stored in a computer readable storage medium (or multiple such media) and implemented on a hardware processor, or (iii) a combination of (i) and (ii); any of (i)-(iii) implement the specific techniques set forth herein.

Techniques of the present invention can provide substantial beneficial technical effects. For example, one or more embodiments provide one or more of:
drastic reduction of the search space while gradually extending the system scope and input feature space by accounting for user interactions, such as interactions of subject matter experts (SMEs) with the supply chain system;
learning and jointly modeling a representation of the SME interactions and the corresponding novel attributes in order to determine a joint embedding in latent space;
training a first machine learning model to analyze SME interactions with reasoning graphs to identify novel attributes, including novel attributes from external data sources (such as social media, regulations, and the like) to be incorporated into a supply chain ontology;
training a second machine learning model to dynamically (re)structure multi-type entities (products, facilities, vehicles, vehicle routes, and the like) and their relationships (for example, products shipped from a supplier’s warehouse) based on their sensitivity to specific input attributes (such as supplier’s location, extreme events, seasonal demand patterns, the identified novel attributes, and the like);
building supply chain health scores based on the climate-aware ontology enrichment process, performance of the supply chain models, and the like to determine when and how to trigger the inference of novel data / attributes;
a system that retrains the first and second machine learning models to enable continuous model enrichment;
a system that continuously tracks the improvements of the ontology and highlights the future trends in the supply chain to subject-matter-experts for enabling resiliency in the supply chain; and
a system that analyzes neighboring supply chain data (such as additional data sources related to the supply chain, including local / national policies, social media data, news headlines, historical product sales, and the like) along with analyzing user interaction with a climate-reasoning graph of a neighboring supply chain and identifies the set of entities and relationships for improving ontology in the supply chain for better understanding the user’s input in the form of natural language text;
controlling a supply chain based on results of a revised ontology generated using aspects of the invention, thus improving a technological process of computerized supply chain control based on machine learning.

Some embodiments may not have these potential advantages and these potential advantages are not necessarily required of all embodiments. These and other features and advantages of the present invention will become apparent from the following detailed description of illustrative embodiments thereof, which is to be read in connection with the accompanying drawings.

### BRIEF DESCRIPTION OF THE DRAWINGS

FIG. 1 depicts a cloud computing environment according to an embodiment of the present invention;

FIG. 2 depicts abstraction model layers according to an embodiment of the present invention;

FIG. 3 is an example graph of demand vs. time for a sweater product, in accordance with an example embodiment;

FIG. 4 is a first example ontology for estimating demand for a sweater during the winter season, in accordance with an example embodiment;

FIG. 5 is a second example ontology for estimating demand for a sweater during the winter season, in accordance with an example embodiment;

FIG. 6 is a system context diagram of an example supply chain management system, in accordance with an example embodiment;

FIG. 7 illustrates an example workflow for a supply chain management system, in accordance with an example embodiment;

FIG. 8 is a block diagram of an example supply chain management system, in accordance with an example embodiment;

FIG. 9 is a flowchart for an example query analyzer, in accordance with an example embodiment;

FIGS. 10A and 10B present a flowchart for an explainable demand forecasting model, in accordance with an example embodiment;

FIGS. 11A-11D illustrate the high-level steps for learning a vector representation from user interactions with a climate-reasoning graph, in accordance with an example embodiment;

FIG. 12 illustrates a twin neural network for identifying the relationship between external events and user interactions with explainable insights, in accordance with an example embodiment;

FIG. 13A graphically illustrates an ontology refinement step performed by analyzing a search space in the latent space for identifying climatic constraints and missing entities, in accordance with an example embodiment;

FIG. 13B illustrates a flowchart of a corresponding method for analyzing a search space in the latent space for identifying climatic constraints and missing entities, in accordance with an example embodiment;

FIG. 14A is a flowchart for an example method for generating explainable insights with feedback, in accordance with an example embodiment;

FIG. 14B is a flowchart for an example method for generating explainable insights with feedback, in accordance with an example embodiment;

FIG. 15 is a flowchart for an example method for performing ontology enrichment, in accordance with an example embodiment; and

FIG. 16 depicts a computer system that may be useful in implementing one or more aspects and/or elements of the invention, also representative of a cloud computing node according to an embodiment of the present invention.

### DETAILED DESCRIPTION

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service’s provider.

Broad network access: capabilities are available over a network and accessed through standard mechanisms that promote use by heterogeneous thin or thick client platforms (e.g., mobile phones, laptops, and PDAs).

Resource pooling: the provider’s computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider’s applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

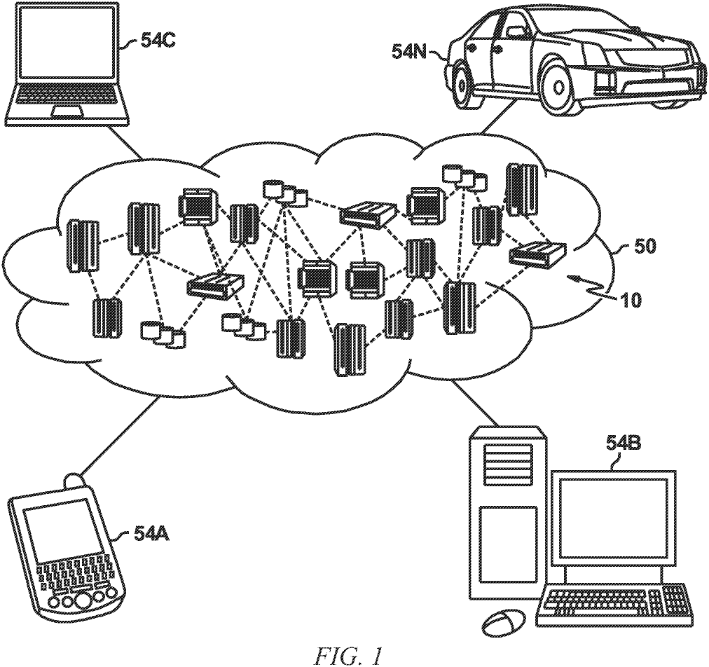

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

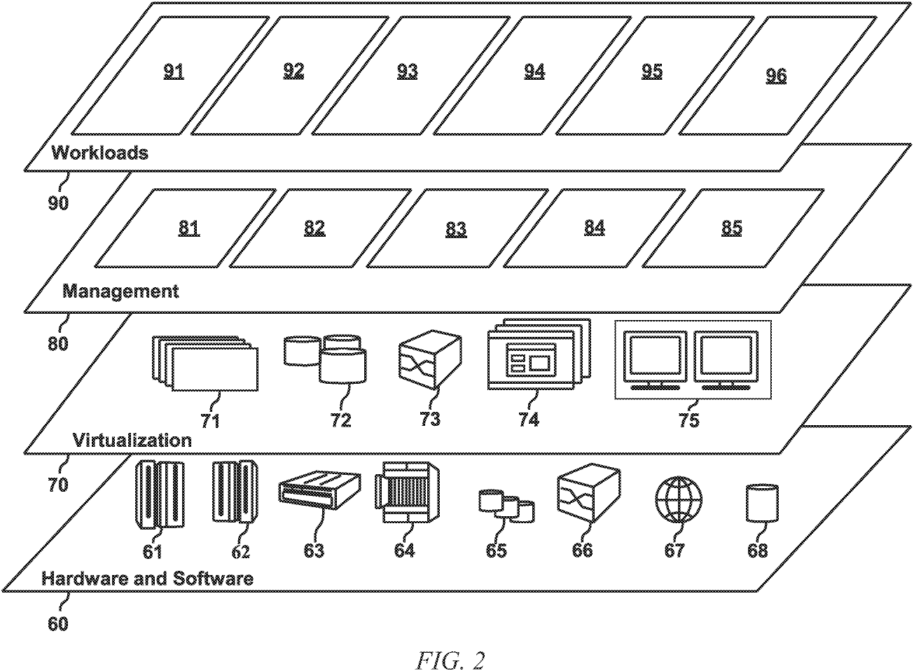

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and at least a portion of a system for supply chain control and management processing 96. For example, one or more embodiments are well-suited for a hybrid cloud environment.

### Introduction: Demand Forecasting With Climate-Aware Capabilities

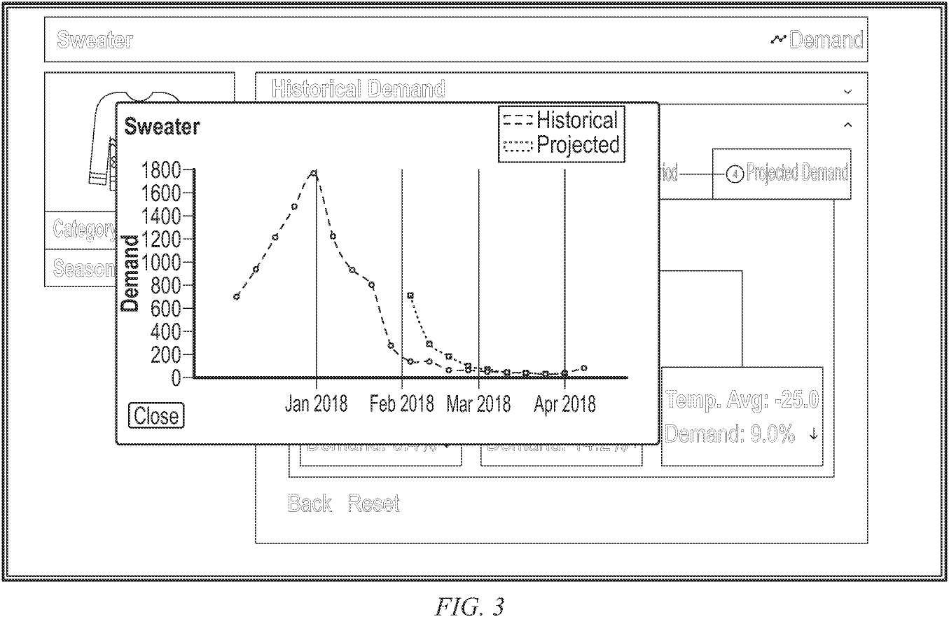

FIG. 3 is an example graph of demand vs. time for a sweater product, in accordance with an example embodiment. (The dashed line represents the historical demand and the dotted line represents the projected demand.) Subject matter experts (SMEs) routinely perform tasks such as demand forecasting. Reasoning graphs with, for example, climate-aware capabilities can provide explainable insights for supply chain managers. Such reasoning graphs can be generated based on ontologies that describe the underlying supply chain operations. Such ontologies can be personalized, such as by auto-revising the entities of the ontology to further guide the supply chain manager (e.g., in demand planning).

### Reasoning Graph With Climatic Attributes

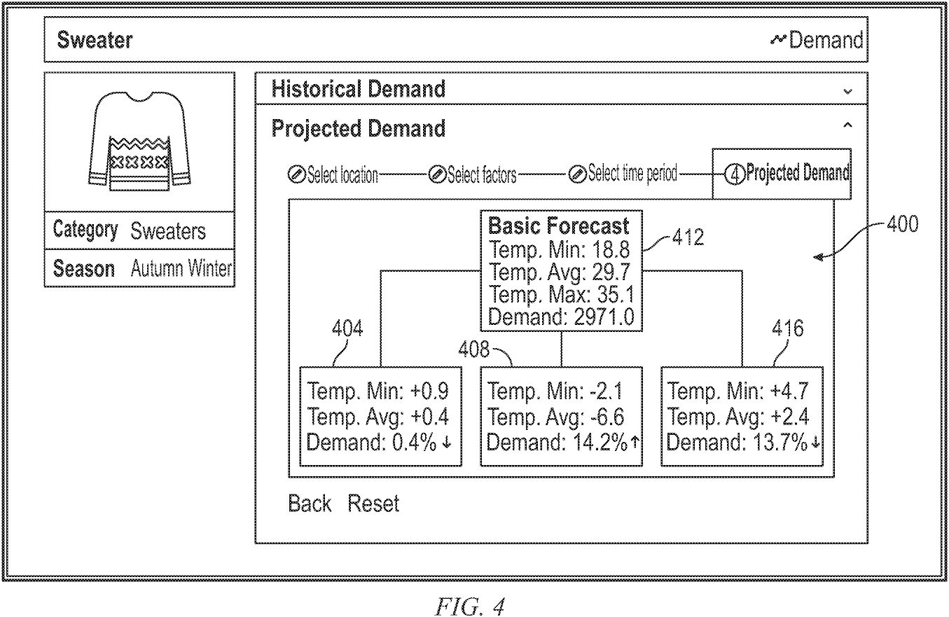

FIG. 4 illustrates a first example ontology for estimating demand for a sweater during the winter season, in accordance with an example embodiment. The graph 400 provides estimates for the impact of forecast temperature changes on demand. For example, the basic forecast 412 is for a minimum temperature of 18.8 degrees, a maximum temperature of 35.1 degrees, and an average temperature of 29.7 degrees (temperature is degrees Fahrenheit). The demand in this situation is 2971 units. Suppose the actual minimum temperature is 0.9 degrees higher than the forecast weather, as indicated by node 404; then the demand will be 0.4% lower. Similarly, a change in the average temperature of -6.6 degrees results in a 14.2% increase in demand (node 408) and a change in the average temperature of +2.4 degrees results in a 13.7% decrease in demand (as indicated node 416).

Fixed ontology attributes and constraints for knowledge graph generation limits the SME to only model the demand forecast based on fixed attributes. New attributes/patterns that capture changes in the demand forecast, such as extreme climatic events or new fashion trends derived from external data sources, such as social media, news, and the like, should be dynamically encoded. In one example embodiment, the ontology is auto-populated or auto-updated to accommodate such changes.

FIG. 5 illustrates a second example ontology 500 for estimating demand for a sweater during the winter season, in accordance with an example embodiment. A product, such as a winter sweater (represented by node 504), has an associated demand (represented by node 508). The demand is dependent, for example, on climate risk (represented by node 512), which in turn is dependent on disruptive events (represented by node 516) and climatic variations (represented by node 520). The definitions of heat waves and cold waves vary from region to region and time to time. Consider how conditions can be automatically defined for heat waves and cold waves, and how new entities and conditions can be automatically incorporated into the ontology 500. For example, conditions for a heatwave (represented by node 524) and a cold wave (represented by node 528) should be defined in the ontology 500. Similarly, conditions for humidity (represented by node 532) and temperature (represented by node 536) should be defined in the ontology 500. In addition, new nodes to represent newly discovered, or soon to be discovered, entities (such as global warming) should be recognized and incorporated into the ontology.

### Dynamically Populating Personalization Parameters

Supply chain ontologies are conventionally maintained by users, such as subject matter experts. In various industries, especially industries that tend to undergo continuous change and evolution, there is an advantage in enabling personalized knowledge representations (e.g., a personalized knowledge graph (KG)). The personalization is created by, for example, examining: (1) the dataset and the trained models of a particular SME; (2) the specific interest of an SME in knowing specific aspects of a supply chain; (3) the evidence (such as model confidence) which supports the KG; and (4) what other similar SME users found to be relevant.

In one example embodiment, ontology attributes and constraint ranges (such as climatic constraints) are dynamically identified in an automated manner based, for example, on the interactions of SMEs with the system. The representation of the ontology is updated with the identified ontology attributes, the identified constraint ranges, or both to further refine the ontology and improve the performance of various supply chain management tasks.

### Scoring a User’s Dataset

Conventional supply chain management systems score not only model bias (based on data), but also determine how suitable a dataset is for counterfactual (CF) interrogation. Some datasets are richer than others in terms of the amount and variety of “good” CFs which can be produced. Consequently, this information can be communicated to specific SME users. One of the better options for the user is to collect specific types of data in order to improve the user’s personalized KG.

In general, the search space can be drastically reduced while gradually extending the system scope and input feature space by accounting for user interactions, such as interactions of the SMEs with the supply chain system. Uncertainty can also be reduced by prompting the user to examine other variables for interrogation and validation. Moreover, user-directed data collection efforts may be utilized in order to understand specific aspects of the corresponding supply chain as there is evidence from the user’s cohorts.

In one example embodiment, a system and corresponding methods for auto-enriching climate-aware supply chain ontologies that improve an SME’s personalization parameter space is disclosed. The improvements enhance the management of the supply chain, such as forecasting retail demand and the like. The supply chain management system and corresponding methods include:
jointly modeling the representation of the SME interactions and the corresponding novel attributes in order to determine the joint embedding in latent space;
training a first machine learning model to analyze SME interactions with reasoning graphs to identify novel attributes from, for example, external data sources (such as social media, regulations, and the like) to be incorporated into a supply chain ontology;
training a second machine learning model to dynamically (re)structure multi-type entities (products, facilities, vehicles, vehicle routes, and the like) and their relationships (for example, products shipped from a supplier’s warehouse) based on their sensitivity to specific input attributes (such as supplier’s location, extreme events, seasonal demand patterns, the identified novel attributes, and the like); and
building supply chain health scores based on the climate-aware ontology enrichment process, performance of the supply chain models, and the like to determine when and how to trigger the inference of novel data and attributes.

### Use Cases

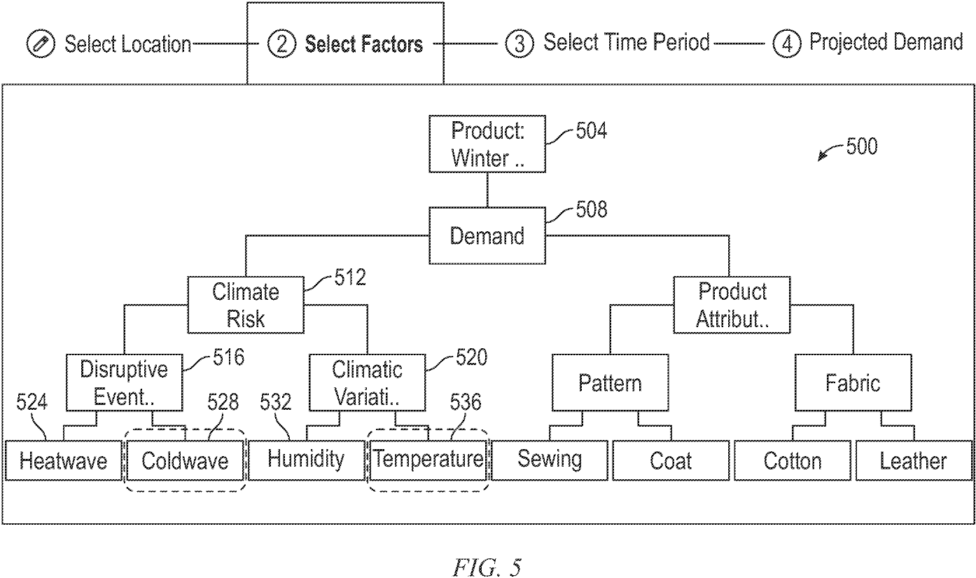

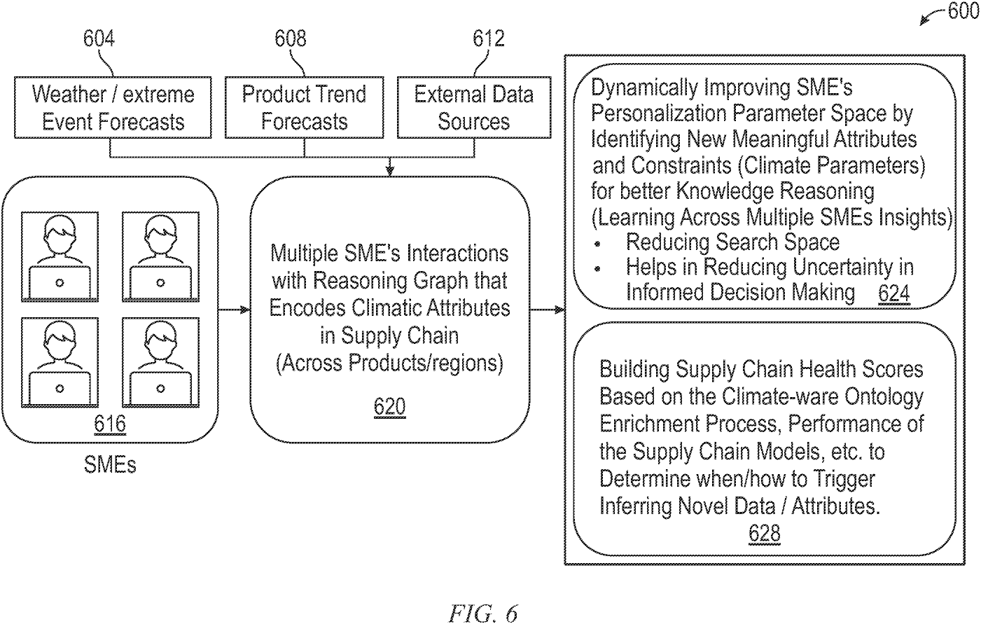

FIG. 6 is a system context diagram 600 of an example supply chain management system, in accordance with an example embodiment. In one example embodiment, a plurality of SMEs 616 interact, at 620, with a reasoning graph that encodes, for example, climatic attributes effecting a supply chain across different products, regions, and the like. The interactions 620 incorporate external data sources, such as weather/extreme event forecasts 604, product trend forecasts 608, and other external data sources 612.

Dynamically improving SME’s personalization parameter space by identifying new meaningful attributes and constraints (such as climate parameters) for better knowledge reasoning (by, for example, learning from the insights of multiple SMEs) achieves a reduction in search space and a reduction in the uncertainty of informed decision making (impact 624). In one example embodiment, supply chain health scores are built based on the climate-ware ontology enrichment process, performance of the supply chain models, and the like, to determine when and how to trigger the inference of novel data / attributes (impact 628). External data sources, such as user articles, social media, and the like, are used in conjunction with user interactions to augment the ontology. User interactions with the reasoning graph are analyzed to learn, for example, which nodes are helpful and to encode additional attributes and constraints into the ontology.

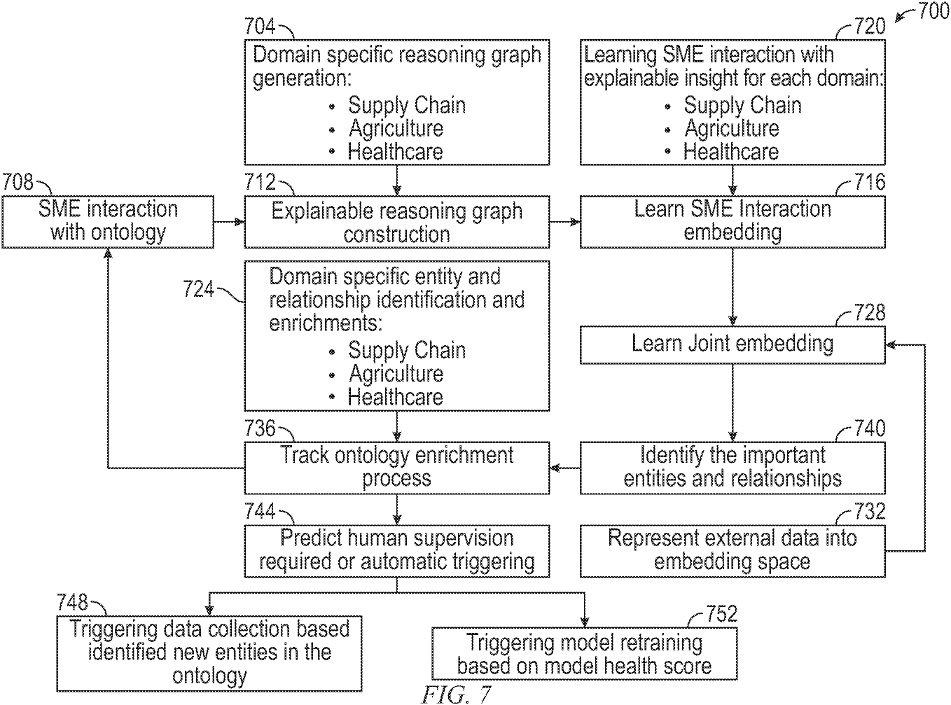

FIG. 7 illustrates an example workflow 700 for a supply chain management system, in accordance with an example embodiment. The workflow 700 can also be applied to other domains, such as agriculture, healthcare, and the like. In one example embodiment, SME interactions with a supply chain ontology are monitored based on the tracked ontology enrichment process (operation 708) and an explainable reasoning graph is constructed (operation 712) based on the monitored SME interactions and domain specific reasoning information 704, such as reasoning information for a supply chain, agriculture and healthcare (dependent on use case). In one example embodiment, the domain specific reasoning information is use case dependent. For example, for healthcare, the domain specific reasoning information may include information regarding a new epidemic, hospital capacity, hospital assets, personnel, trauma kits, medical gear and supplies; availability of vaccines/vaccination strategies; an indication of a shortage of liquid oxygen, a shortage of medical wear (PPE), or a shortage of medicines; and the like. Operation 712 is similar to the construction of a knowledge graph (KG), but with the KG encoded with domain context and domain information. Operation 712 is based on a pre-built machine learning model and instantiated and/or enriched when a user interacts with the system.

In one example embodiment, the explainable insight of the SME interactions is learned (operation 720) and an SME interaction embedding is learned based on the constructed explainable reasoning graph and the explainable insight of the SME interaction (operation 716). The external data is incorporated into the embedding space (operation 732) and a joint embedding is learned based on the generated embeddings (operation 728). During operation 728, while learning the joint embedding between the SME interaction embedding and the external data embedding, key entities and relationships in the reasoning graph that the SME is interested in are selected; for instance, an interest in the demand for cold weather clothing and the effects of humidity and temperature on its demand may be selected. By mapping external data, such as news on an upcoming cold wave in the region of interest and extreme weather forecasts in the region, potential new entities and relationships for the ontology, such as the cold wave and forecasted temperature ranges, are identified. Explainable insights can be identified by User Interaction (UR) with Climate Reasoning Graph Analyzer 816 and Representing External Data into embedding space 732 encoded by a neural network model. Note (actual) learning of SME Interaction Embedding at 716 and joint learning at 728.

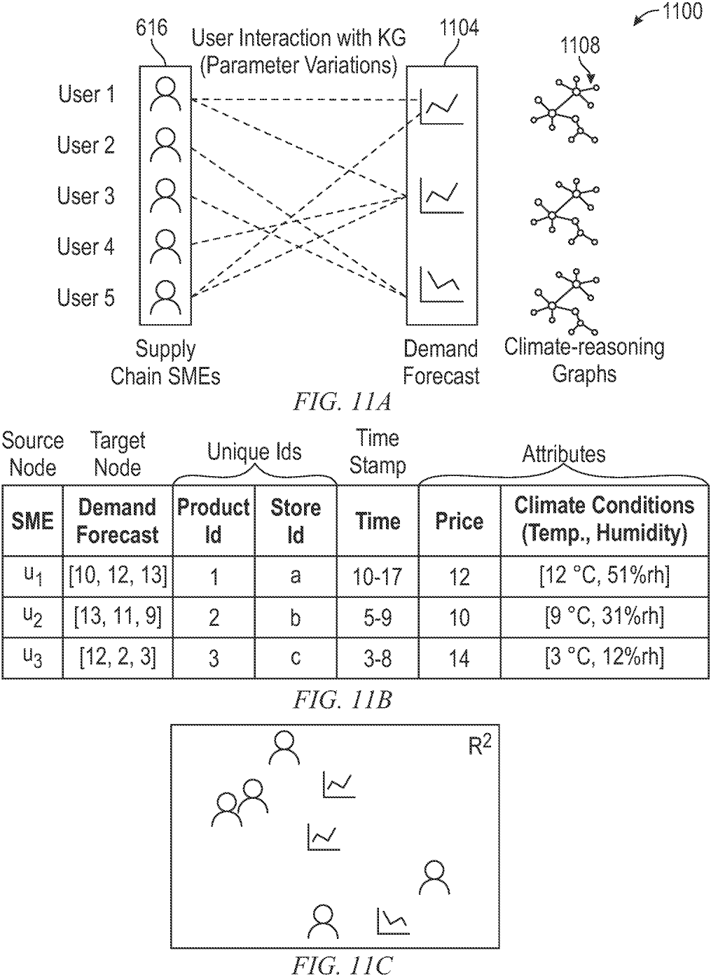

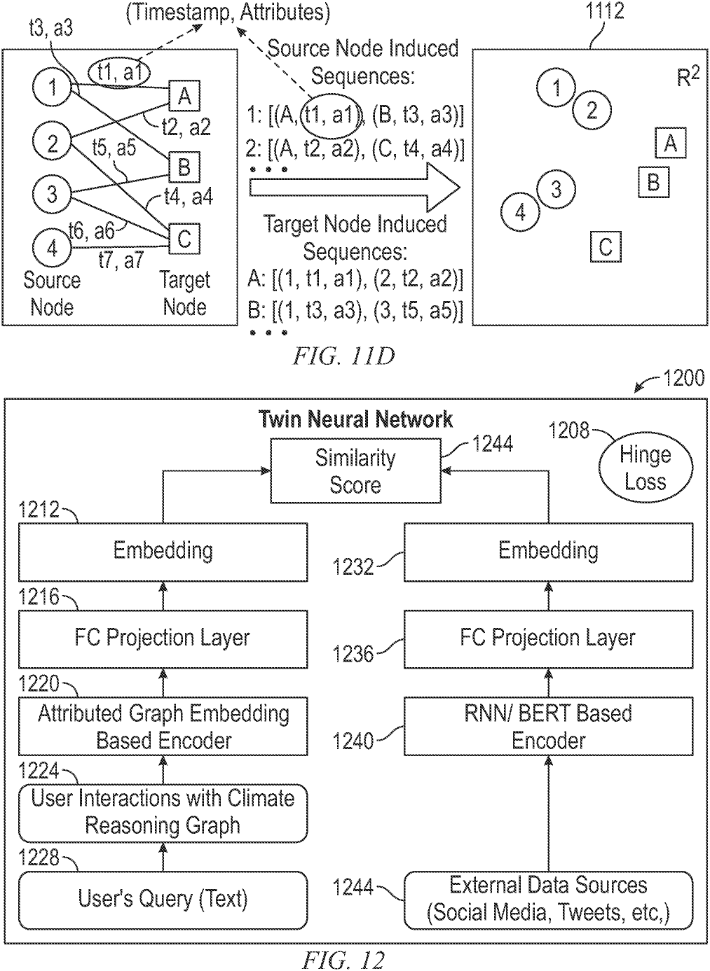

The important entities and relationships are identified based on the joint embeddings (operation 740). For example, the important entities and relationships may be identified by monitoring user interactions with the climate reasoning graph, as described further below in conjunction FIGS. 8 and 11, and in conjunction with the encoding of external data into the embedding space (operation 732), as encoded by a neural network model. The ontology enrichment process is tracked (operation 736) based on the identified entities and relationships, and domain specific entity and relationship identification and enrichments 724 (for, for example, supply chain, agriculture, and healthcare). In one or more embodiments, for example, for block 724, the domain specific entity and relationship identification and enrichments process is undertaken through component 736.

In one example embodiment, the human supervision required is predicted or automatic triggering is performed (operation 744), data collection based on the identified new entities in the ontology are triggered (operation 748), and model retraining based on a model health score is triggered (operation 752). For example, after identifying the important entities and relationships, the ontology is updated (which is initiated by operation 736). This may utilize human supervision or may occur automatically. When human supervision is utilized, the user is alerted. In one example embodiment, extra validation for data collection and curation is performed. Operation 748 performs data collection based on the new entities in the ontology and operation 752 runs the existing models on the updated data (if the scores are below the threshold, the model is retrained on the updated data). This operation may, in turn, trigger collection of more data. Once the model health score requirements are satisfied, the ontology is updated.

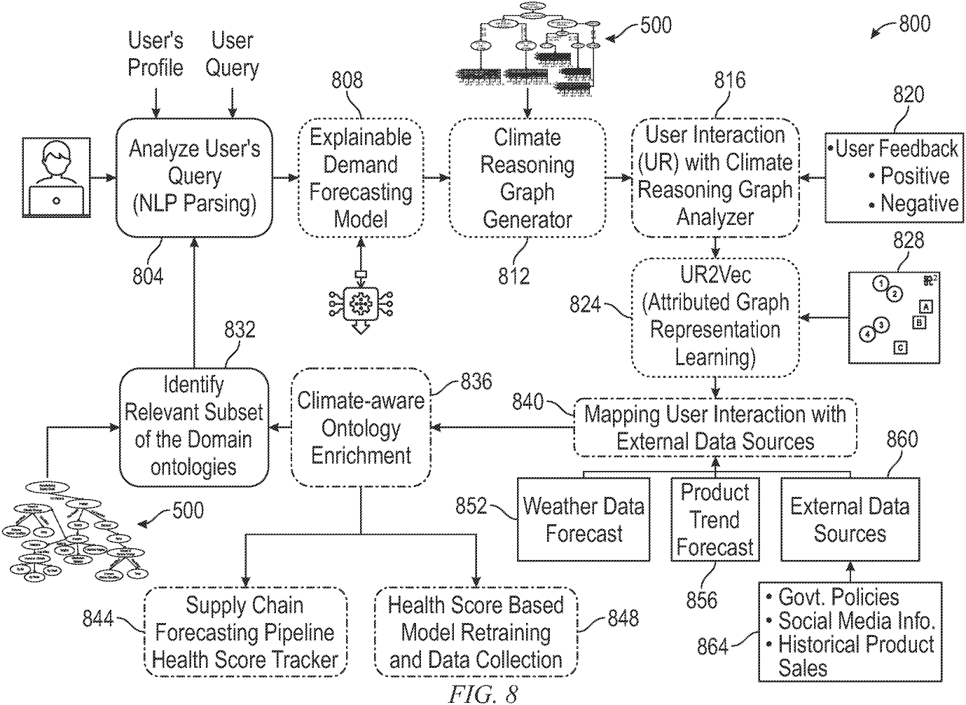

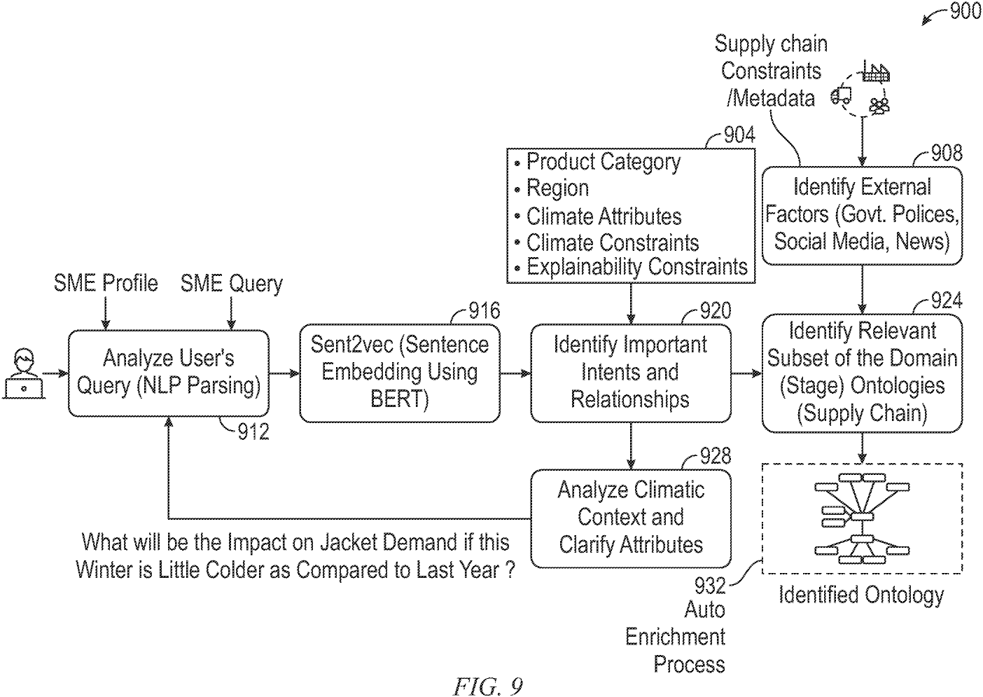

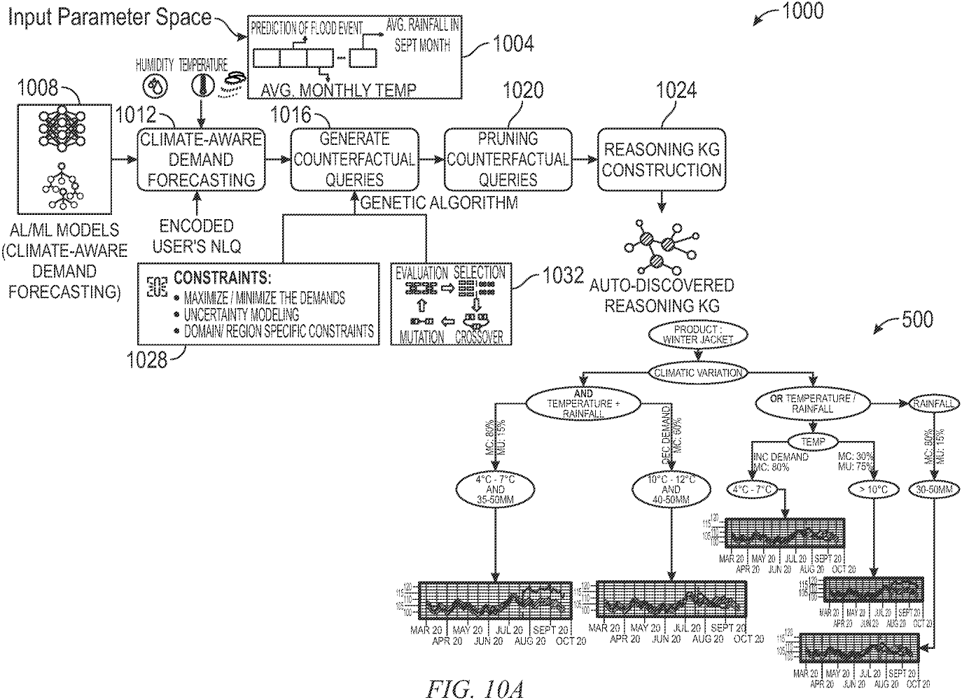

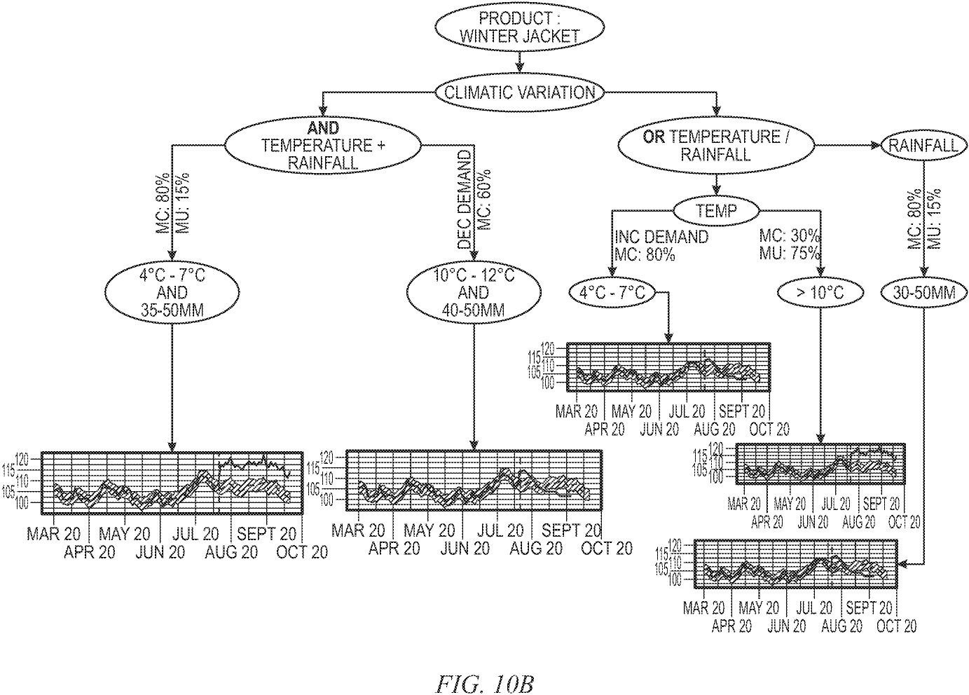

FIG. 8 is a block diagram of an example supply chain management system 800, in accordance with an example embodiment. In one example embodiment, a user’s input queries (in the form of natural language text, user profiles, and the like) are analyzed by a query analyzer 804, as described more fully below in conjunction with FIG. 9, and an explainable demand forecasting model 808 is generated based on the initial version of the ontology, as described more fully below in conjunction with FIGS. 10A and 10B. A climate reasoning graph generator 812 generates a climate reasoning graph to aid in understanding the variations of product demand concerning climatic variations using explainable machine learning models with the help of the explainable demand forecasting model 808, as described more fully below in conjunction with FIGS. 10A and 10B.

A user interaction (UR) with climate reasoning graph analyzer 816 analyzes the users’ interactions with an auto-generated climate reasoning graph to understand the user’s context for analyzing product demand variations in the supply chain, as described more fully below in conjunction with FIGS. 11A-11D. The analysis is based, for example, on user feedback 820 provided by the SMEs.

Attributed graph representation learning system 824 analyzes historical user interactions with the climate-reasoning graph and learns a vector representation of the users’ interactions 828 using attributed graph representation learning that captures variations of the demand forecast along with external factors such as climate attributes, product metadata, and the like. This operation involves receiving, as input, the user interaction with the climate reasoning graph with the goal of generating an embedding of the user interaction with the climate reasoning graph. The attributed graph representation learning system 824 models an attributed interaction graph between the users’ interaction and explainable demand forecasts utilizing attributed graph representation learning. This involves first learning a vector representation of the users’ interaction that captures variations in demand forecasts, climate attributes and product metadata in the attributed interaction edges and, second, learning the node embedding in the attributed graph such that it captures the users’ most important entities in the climate reasoning graph.

A user interaction mapper 840 learns the node embedding in the attributed interaction graph by analyzing different users’ interactions with the climate-reasoning graph such that it captures important entities identified in the climate-reasoning graph, as described more fully below in conjunction with FIG. 12. The user interaction mapper 840 analyzes external data sources, such as weather data forecast 852; product trend forecasts 856; government policies, social media information, and historical product sales 864; and external data sources 860 for identifying missing entities and relationships in the initial or current version of the ontology. The user interaction mapper 840 learns the joint embedding of user interaction embedding via the attributed network graph and the external data sources by learning twin networks, as described more fully below in conjunction with FIG. 12.

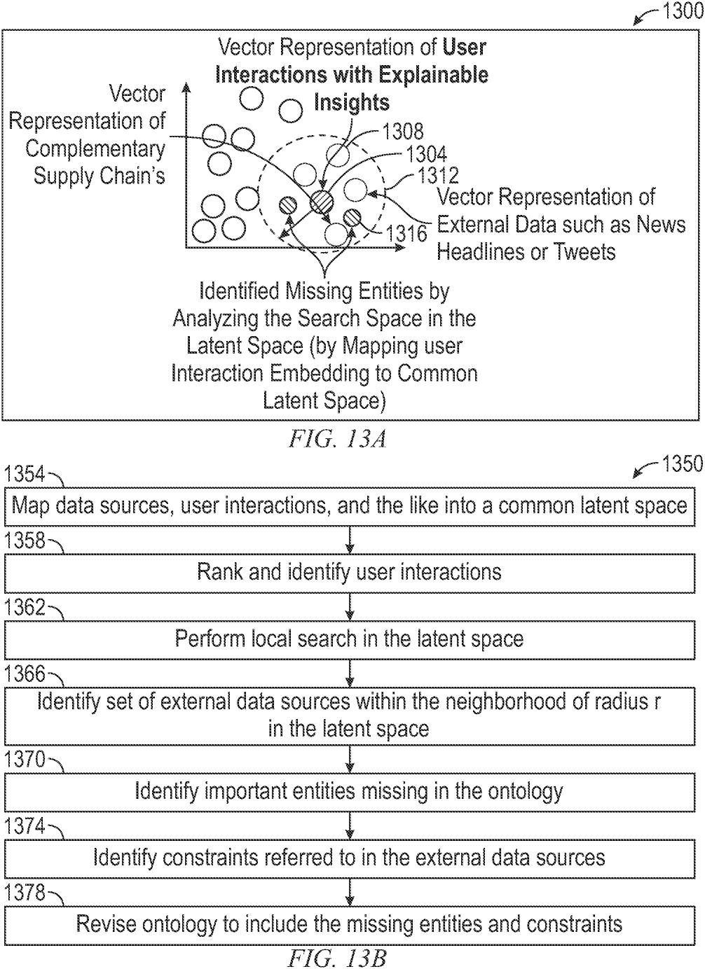

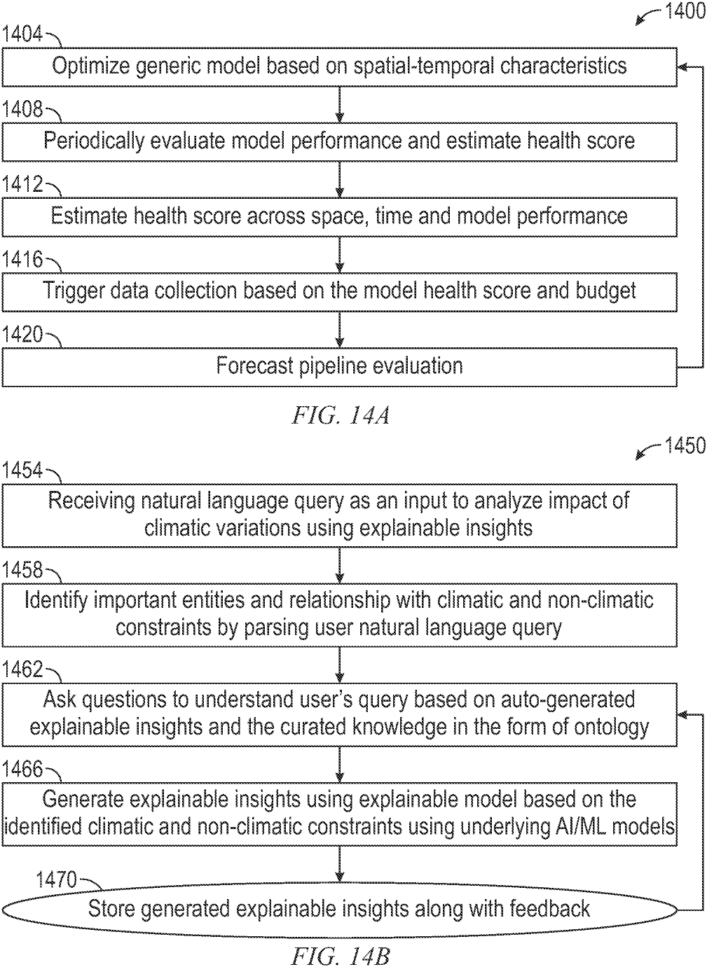

A climate-aware ontology enrichment module 836 identifies a set of missing entities and relationships by perturbing the joint embedding space generated from external data sources and user interaction embedding, and compares the result of the perturbation with the previously generated ontology, as described more fully below in conjunction with FIG. 13. The retraining of the health score based models and data refresh will generate novel ontology entities and attributes hence incorporating future trends that will enhance the ontology. A supply chain forecasting pipeline health score tracker 844 checks the validity of the supply chain forecasting models by ensuring the supply chain forecasting models meet a health score based on model uncertainty, model performance and surrogate loss function for a given region and time. This is performed periodically or when either data is updated or the ontology entities/relationships are updated, as described more fully below in conjunction with FIGS. 14A and 14B.

A health score based model retraining and data collection module 848 collaborates with the supply chain forecasting pipeline health score tracker 844 and retrains the supply chain forecasting models, validating the models that meet the health scores. The health score based model retraining and data collection module 848 entity also triggers the necessary data collection required for retraining the models, as described more fully below in conjunction with FIGS. 14A and 14B.

An ontology updater 832 analyzes the user’s feedback on the previously auto-generated ontology 500 and performs refinement operations for generating an enhanced version of the ontology 500 by identifying the relevant subset of the domain ontologies. The ontology updater 832 retrieves a subset of the ontology tree that is to be updated based on the ontology entities and relationships that have been developed by the climate-aware ontology enrichment module 836. The result of the ontology updater 832 is an updated domain ontology with new/updated entities and relationships.

Consider how dynamic feedback from multiple SME interactions can be incorporated with explainable insights and the feedback provided for the explainable insights (such as positive vs negative feedback from a user) in a continuous ontology enrichment process that will help in improved decision making. FIG. 9 is a flowchart 900 for an example query analyzer 804, in accordance with an example embodiment. In one example embodiment, the query analyzer 804 performs the analysis of a user’s query using natural language processing (NLP). Initially, a user’s query is analyzed (operation 912). The analysis may be performed using natural language processing (NLP) based, for example, on a profile of a corresponding SME. A sentence to vector (Sent2vec) embedding is performed using, for example, a bidirectional encoder representation from transformer (BERT) (operation 916). Important intents and relationships are identified (operation 920) based, for example, on product category, region, climate attributes, climate constraints and explainability constraints 904. The climatic context is analyzed and attributes are clarified (operation 928). Operation 928 supplies a feedback loop to the user enabling refinement of the ontology enrichment by ensuring that the identified intents and relationships match the user’s requirement. External factors, such as government policies, social media, news, and the like, are identified (operation 908) and the relevant subset of the domain (stage) ontologies are identified (operation 924) based on the external factors 908. Similar to entity 832, operation 924 retrieves a subset of the ontology tree that is to be updated based on the ontology entities and relationships that have been developed during operation 920. The result of operation 924 is an updated domain ontology with new/updated entities and relationships. Operation 932 encapsulates the output of the query analyzer 804, which is an updated ontology awaiting a next step of auto enrichment, either based on new insights from user interaction with the climate reasoning graph or new external data, such as news, headlines and the like, related to the specific supply chain 350.

FIGS. 10A and 10B present a flowchart 1000 for an explainable demand forecasting model 808, in accordance with an example embodiment. In one example embodiment, climate-aware demand forecasting is performed based on an input parameter space, an encoded natural language query of a user (such as that provided by query analyzer 804, and AL/ML models 1008 (operation 1012). Input parameter space 1004 represents the input space for the demand forecasting (which can constitute, for instance, time series for precipitation, temperature or flood prediction values for a given location). Counterfactual queries are generated (step 1016) based on the demand forecasting, various constraints 1028 (such as maximize/minimize the demands, uncertainty modeling, domain/region specific constraints, and the like) and a genetic algorithm 1032 (i.e., a metaheuristic inspired by the process of natural selection that belongs to the larger class of evolutionary algorithms (EA)). The generated counterfactual queries are pruned (operation 1020) and a reasoning knowledge graph 500 is constructed (operation 1024). It is worth noting that element 812 can implement the method of FIGS. 10A and 10B for example. Counterfactual query generation is based, for example, on the output of the demand forecasting, various constraints (such as maximize/minimize the demands, uncertainty modeling, domain/region specific constraints, and the like) and a genetic algorithm. Generally, the genetic algorithm relates to a search-based optimization technique that generates a set of counterfactual queries to find optimal (or near-optimal) solutions using selection, crossover, and mutation operations in an iterative manner. The objective of the genetic algorithm is to traverse the search space by generating counterfactual queries. The counterfactual queries are then consolidated by performing one or more clustering techniques on a counterfactual query space to construct a knowledge graph such that it helps in explaining the impact associated with minimizing or maximizing a cost function. Counterfactual query pruning is then applied to the counterfactual queries based on, for example, the one or more constraint(s) (such as maximize/minimize the demands, uncertainty modeling, domain/region specific constraints, and the like). Note that FIG. 10B is an enlarged view of the exemplary ontology of FIG. 10A.

### Modeling User Interaction With Climate Reasoning Graph Using Attributed Graph Embedding

FIGS. 11A-11D illustrate the high-level steps for learning a vector representation from user interactions with a climate-reasoning graph, in accordance with an example embodiment. FIG. 11A illustrates an attributed interaction graph 1100 representing interactions between SMEs 616 and explainable demand forecasts 1104 and climate reasoning graphs 1108, in accordance with an example embodiment. FIG. 11B illustrates a table of the attributed interaction edges of the attributed interaction graph 1100, in accordance with an example embodiment. For example, SME u₁ interacts with demand forecasts 10, 12, and 3 at the specified time and with the specified attributes. Similarly, SME u₂ interacts with demand forecasts 13, 11, and 9 and SME u₃ interacts with demand forecasts 2, 2, and 3.

FIG. 11C illustrates an example of node embedding for the attributed interaction graph 1100, in accordance with an example embodiment. FIG. 11D illustrates an example of attributed interaction graph representation learning, in accordance with an example embodiment. Node embeddings 1112 that capture the entities in the climate reasoning graph that are important to the user are generated from the attributed interaction graph 1100.

### Mapping User Interactions With External Data Sources

FIG. 12 illustrates a Twin Neural Network 1200 for identifying the relationship between external events and user interactions with explainable insights, in accordance with an example embodiment. The Twin Neural Network 1200 learns a correlation between two embeddings, mapping user interactions with an external data source(s) (social media, policy change, and the like). The Twin Neural Network 1200 is trained on a set of labeled data, and is used in enriching the ontology 500 by identifying missing entities, constraints, or both around the same. In general, user interactions are analyzed using an attributed graph embedding based encoder 1220 whereas textual data of external events, such as tweets, are analyzed using a recurrent neural network (RNN) / BERT-based transformer 1240. A joint embedding is learnt using a hinge loss 1208 to align SME interactions and external data sources. As used herein, a twin neural network is an artificial neural network that uses the same weights while working in tandem on two different input vectors to compute comparable output vectors.

In one example embodiment, a user’s query 1228, such as a textual query, and a user’s interactions 1224 with a climate reasoning graph are obtained. The user’s interactions 1224 are processed by the attributed graph embedding-based encoder 1220. The output of the attributed graph embedding-based encoder 1220 is passed through fully-connected (FC) projection layer 1216 to generate embedding 1212.

In one example embodiment, data from external data sources 1244, such as social media, tweets, and the like, is passed through the RNN / BERT-based encoder 1240, followed by a fully-connected (FC) projection layer 1236 to generate embedding 1232. A similarity score module 1244 learns a joint embedding using a hinge loss to align SME interactions and external data sources. In one or more embodiments, entity 840 in FIG. 8 performs mapping of user interactions with external data sources into the common latent space. This is done using a twin neural network as shown in FIG. 12. The twin neural network learns the joint embedding using hinge loss.

### Ontology Refinement Step

FIG. 13A graphically illustrates an ontology refinement step and FIG. 13B illustrates a flowchart 1350 of a corresponding method performed by analyzing a search space in the latent space 1300 for identifying climatic constraints and missing entities, in accordance with an example embodiment. A vector representation 1304 of user interactions with explainable insights and a vector representation 1308 of external data, such as news headlines, tweets, and the like, are depicted in the common latent space 1300. A neighborhood 1312 is defined for the vector representations of the top ranked user interactions with explainable insights within the latent space 1300. This provides the search space for external data representations that can be decoded and included the ontology. A vector representation 1316 of external data that lies within the radius of the neighborhood 1312 is depicted in the common latent space 1300.

In one example embodiment, different data sources (information), such as external data sources (news headlines), user interactions with explainable insights, and the like, are mapped into the common latent space 1300 (operation 1354). The most promising user interactions with explainable insights are identified by performing ranking. A ranker uses the feedback provided (by SMEs) against the explainable insights (operation 1358).

A local search in the latent space 1300 is performed for the identified top k user interactions with explainable insights across multiple SMEs to identify the missing entities, and/or climatic or non-climatic constraints (operation 1362).

A set of external data sources that are within the neighborhood of radius r in the latent space 1300 are identified (operation 1366). The important entities which are missing in the current version of the ontology are identified (operation 1370). Any constraints that need to be added against climatic and non-climatic parameters which are referred to in the external data sources (but not mentioned in the current version of the ontology) are identified (operation 1374). The ontology is revised to include the missing entities, and missing climatic and non-climatic constraints (operation 1378).

In one example embodiment, the method of flowchart 1350 is performed by the climate-aware ontology enrichment module 836 given the mapping of the user interactions with the explainable insights into the common latent space in the form of vector representations using the twin neural network 1200. A ranking of the most promising user interactions with the explainable insights is performed and a search is conducted for vector representations in the latent space of the most promising user interactions with explainable insights. Once these most promising user interactions with explainable insights vector representations are identified, the neighborhood of that vector is searched for external data source vector representations. The external data sources related to these representations are checked and a verification of whether the promising user interactions are represented in the current ontology, either as entities or climatic or non-climatic constraints, is performed. The missing entities and constraints are then added to the ontology.

### Pipeline Health Score Estimation and Model Retraining

FIG. 14A is a flowchart for an example method 1400 for generating explainable insights with feedback, in accordance with an example embodiment. In one example embodiment, the supply chain forecasting pipeline health score tracker 844 and the health score based model retraining and data collection module 848 implement the method 1400.

In one example embodiment, a generic model is optimized based on spatial-temporal characteristics (similar to multitask learning) and flexibility to allow multiple models (operation 1404). Model performance is periodically evaluated in the different spatial-temporal dimensions and a health score is estimated (operation 1408). The health score is estimated as a function of model uncertainty, model performance and surrogate loss function (over forecasting / under forecasting) for a given region and time. The health score across space (locations, such as City A, City B, and the like), time (seasonality, such as winter, summer, extreme events, and the like), and model performance is estimated (operation 1412). Data collection based on the model health score and budget is triggered (operation 1416). A pipeline evaluation is forecasted (incremental data allocation and fine-tuning loss function; multitask learning) (operation 1420). Operations 1404-1420 are then repeated.

FIG. 14B is a flowchart for an example method 1450 for generating explainable insights with feedback, in accordance with an example embodiment. In one example embodiment, method 1450 is performed by the query analyzer 804. In one example embodiment, a natural language query is received as an input to analyze the impact of climatic variations using explainable insights (operation 1454). Important entities and relationships with climatic and non-climatic constraints are identified by parsing a user natural language query (operation 1458). Question(s) are asked to understand a user’s query based on auto-generated explainable insights and the curated knowledge in the form of an ontology (operation 1462). Explainable insights are generated using an explainable model based on the identified climatic and non-climatic constraints using underlying artificial intelligence (AI) / machine learning (ML) models (operation 1466). Generated explainable insights are stored along with feedback (operation 1470).

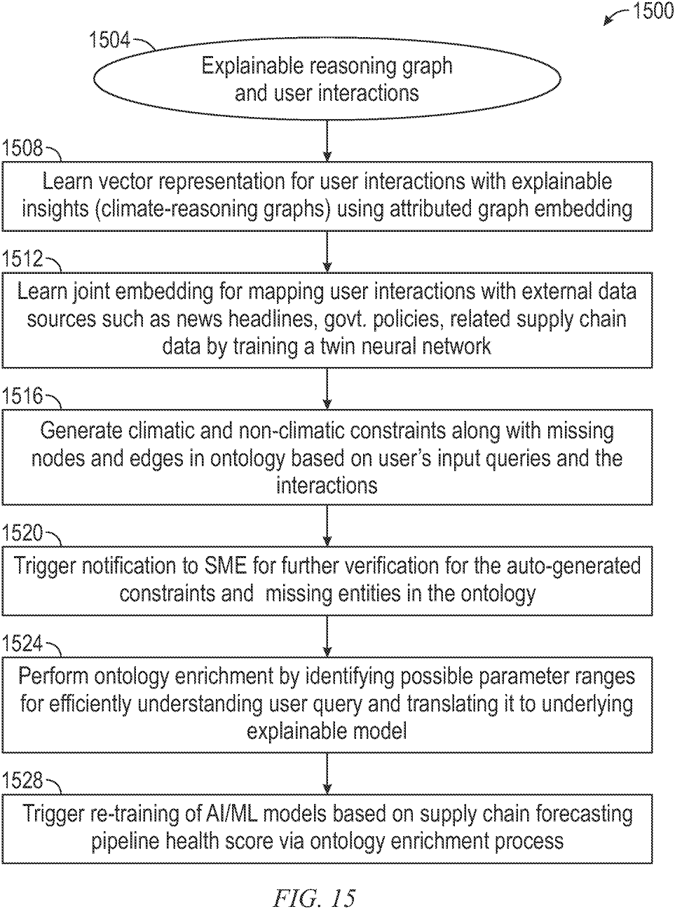

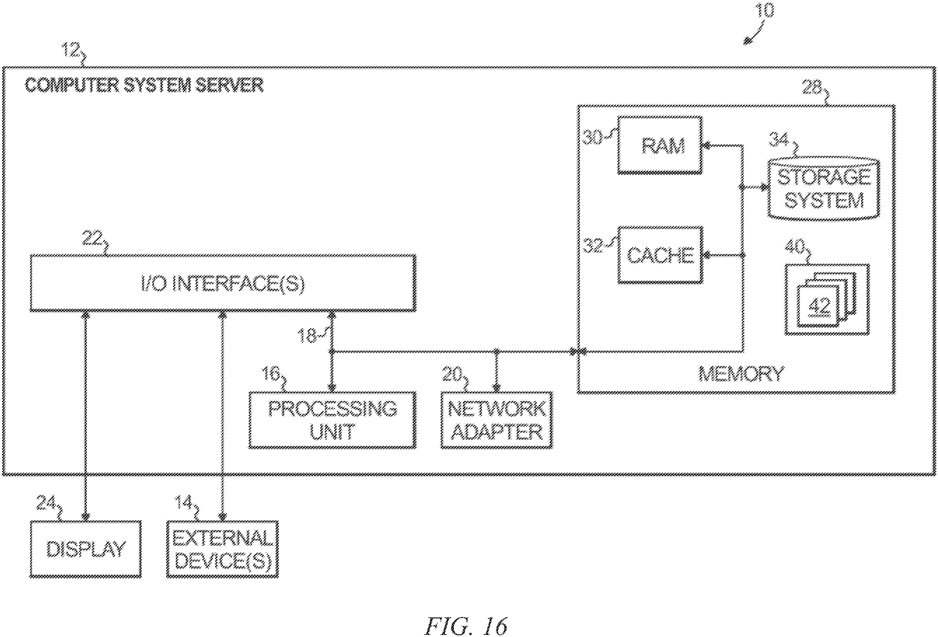

FIG. 15 is a flowchart for an example method 1500 for performing ontology enrichment, in accordance with an example embodiment. In one example embodiment, an explainable reasoning graph and user interactions are obtained (operation 1504; user interaction (UR) with climate reasoning graph analyzer 816). A vector representation for user interactions with explainable insights (climate-reasoning graphs) is learned using an attributed graph embedding (operation 1508; user interaction (UR) with climate reasoning graph analyzer 816 and the attributed graph representation learning system 824). A joint embedding for mapping user interactions with external data sources, such as news headlines, government policies, related supply chain data, and the like, are learned by training a twin neural network 1200 (operation 1512; user interaction mapper 840). Climatic and non-climatic constraints are generated along with missing nodes and edges in an ontology based on a user’s input queries and the user interactions (operation 1516; climate-aware ontology enrichment module 836 and the ontology updater 832). A notification to an SME(s) is triggered for further verification of the auto-generated constraints and missing entities in the ontology (operation 1520; query analyzer 804). Ontology enrichment is performed by identifying possible parameter ranges for efficiently understanding a user query and translating it to an underlying explainable model (operation 1524). Retraining of AI/ML models based on a supply chain forecasting pipeline health score via the ontology enrichment process is triggered (operation 1528). In one example embodiment, the supply chain forecasting pipeline health score tracker 844 confirms whether health score requirements are met. If the health score requirements are not met, the health score based model retraining and data collection module 848 is triggered for processing.

### Application to Other Domains: Agriculture Use Case

Consider a reasoning graph for describing the predicted yield of a crop based on biotic and abiotic stress, such as drought stress damage, drought stress tolerance, heat tolerance, and cold tolerance (among other attributes). The disclosed techniques, methods, and system can be adapted for such a use case through the following steps:

Starting with a predefined ontology, analyze the SME’s interaction with the reasoning graph, identifying important intents and relationships such as crop category and variety, region, biotic and abiotic factors, and the like.

Identify novel attributes for incorporating into the ontology based on climatic forecast, extreme event forecasts, and news or social media (such as fertilizer shortage, disease spread, potential army worm invasion, and the like) (This is learning the joint embedding space between the SME interaction and the novel attributes. For instance, based on the shortage of available fertilizer, the potential impact on crop yield can be assessed through yield prediction mode).

Dynamically restructure the multi-type entities and their relationships based on their sensitivity to specific input attributes, such as crop location, extreme events, the identified novel attributes (such as identification of new disease, revised constraint parameters for attributes (such as heat and cold waves), drought stress, shortage of fertilizer, disruption of rain/dry seasons impacting harvest, change in import/export strategy, and the like) (ontology enrichment process).

Build a health score pipeline based on the ontology enrichment process and performance of the yield prediction models to determine when/how to trigger inference of novel data/attributes.

Enable retraining/fine-tuning/transfer learning to incorporate new attributes (such as percentage of disease spread, size of army worm infestation, and the like) into the ontology by performing data collection (such as regions expected to be impacted from news reports, changes in import/export strategy, and the like) and, based on yield predictions model repository and using a mix of process based models (WOFOST) and machine learning models, evaluating the updated yield prediction based on the newer ontology attributes.

### Application to Other Domains: Health Care Use Case

Consider a reasoning graph for describing the regional planning and management of medical services for preparedness during emergency situations such as pandemic or disasters such as disease outbreak. The disclosed techniques, methods, and system can be adapted for such a use case through the following steps:

Starting with a predefined ontology, analyze the SME’s interaction with the reasoning graph to identify important intents and relationships, such as available health facilities and their capacity, hospital assets, personnel and trauma kits, medical gear and supplies, and the like.

Identify novel attributes for incorporating into the ontology based on monitored epidemic/pandemic spread (such as setting/lifting of cross border travel restrictions), extreme event forecasts (such as hurricanes/flood-water borne diseases and news or social media, a such as news reports on new medicines, vaccine availability, and the like). (This is learning the joint embedding space between the SME interaction and novel attributes. For instance, in a pandemic, a change in a lockdown strategy, new measures for masking and their mapped impact on newer disease cases, can be crucial in measuring the stress on medical services.

Dynamically restructure the multi-type entities and their relationships based on their sensitivity to specific input attributes (such as location, extreme events, the identified novel attributes like a new epidemic, availability of vaccines/vaccination strategies, shortage of liquid oxygen, shortage of medical wear(PPE), shortage of medicines, and the like) (ontology enrichment process).

Machine learning models for determining stress on medical services based on predicted casualties.

Building a health score pipeline based on the ontology enrichment process and performance of the medical stress prediction models to determine when/how to trigger inference of novel data/attributes, including enabling retraining/model fine tuning to measure stress level on medical services on identified new attributes in a given location and performing data collection (such as report on daily cases, hospitalizations across regions of interest, news reports on change in policies governing disease control, social media feed, and the like).

Given the discussion thus far, it will be appreciated that, in general terms, an exemplary method, according to an aspect of the invention, includes the operations of training a first machine learning model for analyzing user interactions with one or more domain specific reasoning graphs 1108 to identify attributes suggested by external data sources 1244 (operations 804-816); jointly modelling a representation of the user interactions with the one or more domain specific reasoning graphs 1108 and a representation of the attributes of external data sources 1244 in a common latent space to determine a joint embedding in latent space (operations 824 and 840; operation 728) (learning a domain-specific joint embedding space to identify entities and relationships absent from an ontology based on the learned joint embedding space (operation 840)); training a second machine learning model to dynamically restructure multi-type entities and their relationships based on their sensitivity to specific input attributes and the identified entities and relationships (operations 832-836); and building a machine learning model health score tracker based on the first and second machine learning models (operations 832-836 and 844-848).

Thus, one or more embodiments provide a method which comprises training a first machine learning model for analyzing user interactions with domain specific reasoning graphs to identify novel attributes suggested by external data sources. This first part involves jointly modelling a representation of the user interactions with the reasoning graph and the representation of novel attributes of external data in a common latent space. From the learnt domain specific joint embedding space, missing entities and relationships for the ontology are identified. Second, a machine learning model is used to dynamically restructure multi-type entities and their relationships based on their sensitivity to specific input attributes (based on the suggested new entities and relationships in the ontology). A machine learning model health score tracker ensures that the performance of the domain specific forecasting models meets a set criteria even with the updated ontology.

In one example embodiment, user interactions with a supply chain system 350 are monitored based on a tracked ontology enrichment process (operation 708); an explainable reasoning graph 1108 is constructed based on the monitored user interactions and domain specific reasoning information 704 (operation 712); an explainable insight of the monitored user interactions is learned (operation 720); a user interaction embedding for an embedding space is learned based on the constructed explainable reasoning graph 1108 and the explainable insight (operation 716); external data 1244 is incorporated into the embedding space (operation 732); a joint embedding is learned based on the user interaction embedding (operation 728); missing entities and relationships are identified for incorporation into an ontology based on the user interactions and joint embedding (operation 740); the ontology is revised to incorporate the missing entities and relationships into the ontology to create a revised ontology (operation 736); and a supply chain 350 is controlled based on the revised ontology. Note that constraints in the ontology refer, for example, to a range of acceptable values for a given property; for instance, in the climate reasoning graph for the supply chain, a region temperature between 25-32° C. The relationships in the ontology (for instance, in the climate aware supply chain use case) include a subtree which highlights climatic conditions affecting demand of cold weather clothing. A new entity such as a cold wave may be identified; this is appended to the ontology subtree. Furthermore, in some instances, controlling the supply chain involves a physical change such as storing more inventory in a warehouse, moving a manufacturing location to a more stable location, or the like.

In one example embodiment, data collection based on the identified missing entities is triggered; a model health score is generated; and a forecasting model is retrained based on the model health score (operation 752). For example, these are the domain specific forecasting models (e.g., component 844 shows supply chain forecasting models). Model health scores can be generated for the supply chain forecasting models, and the supply chain forecasting models retrained if necessary.

In one example embodiment, an explainable demand forecasting model 808 is generated based on an initial version of the ontology; a climate reasoning graph to aid in understanding variations of product demand concerning climatic variations is generated using explainable machine learning models with the explainable demand forecasting model 808; a user interaction with the climate reasoning graph is analyzed to understand a context for analyzing product demand variations in a supply chain; historical user interactions (i.e., user interactions other than current user interactions) with the climate-reasoning graph are analyzed and a vector representation of the user interactions 828 with the climate-reasoning graph is learned using an attributed interaction graph derived via attributed graph representation learning that captures variations of a demand forecast and external factors from one or more external data sources; a node embedding in the attributed interaction graph is learned by analyzing different users’ interactions with the climate-reasoning graph such that it captures important entities identified in the climate-reasoning graph; a previously generated ontology is compared; and user feedback regarding the previously generated ontology 500 is analyzed and refinement operations for generating an enhanced version of the ontology 500 are performed by identifying a relevant subset of the domain ontologies, wherein the learning the joint embedding is performed by learning twin networks and wherein the identifying the missing entities and relationships further comprises perturbating a joint embedding space generated from the external data sources and the user interaction embedding.

In one example embodiment, a table of attributed interaction edges of the attributed interaction graph 1100 is generated.

In one example embodiment, a correlation between the joint embedding is learned and user interactions with an external data source are mapped (joint embedding of user interaction embedding via attributed network graph and the external data sources); a twin network 1200 is trained on a set of labeled data; the twin network 1200 is used in enriching the ontology 500 by identifying additional missing entities, constraints, or both; the user interactions are analyzed using an attributed graph embedding based encoder 1220; external events are analyzed using a first recurrent neural network (RNN) / bidirectional encoder representation from transformer (BERT)-based transformer 1240; user interactions 1224 with a climate reasoning graph are obtained; output of the attributed graph embedding-based encoder 1220 is processed using a first fully-connected (FC) projection layer 1216 to generate a first embedding 1212; data from the external data sources 1244 is processed using a second RNN / BERT-based encoder 1240 followed by a second fully-connected (FC) projection layer 1236 to generate a second embedding 1232; one or more of the external data sources 1244 and user interactions with explainable insights are mapped into a common latent space 1300 (operation 1354); one or more most promising user interactions with explainable insights are identified by performing ranking based on user feedback (operation 1358); a local search in the latent space 1300 for a top k of the identified user interactions with explainable insights is performed to identify the missing entities and missing constraints (operation 1362); a set of the external data sources 1244 that are within a neighborhood of radius r in the latent space 1300 are identified (operation 1366); important entities which are missing in the ontology are identified (operation 1370); constraints that are referred to in the external data sources 1244 and are to be incorporated into the ontology are identified (operation 1374); and the ontology 500 is revised to include the missing entities and missing constraints (operation 1378), wherein the learning the joint embedding uses a hinge loss to align the user interactions and external data sources 1244.

In one example embodiment, a generic forecasting model is optimized based on a spatial-temporal characteristic (operation 1404); a performance of the optimized forecasting model is periodically evaluated in different spatial-temporal dimensions and a model health score (with respect to domain specific forecasting models; for instance, component 844 shows supply chain forecasting models) is estimated (operation 1408); data collection is triggered based on the model health score and a corresponding budget (operation 1416); and a pipeline evaluation is forecasted (operation 1420).

In one example embodiment, a natural language query is received as an input to analyze an impact of climatic variations using explainable insights (operation 1454); one or more additional entities and relationships with constraints are identified by parsing the natural language query (operation 1458); one or more questions are issued to understand a user’s query based on auto-generated explainable insights and curated knowledge in a form of the ontology 500 (operation 1462); one or more explainable insights are generated using an explainable model based on the identified constraints (operation 1466); and the generated explainable insights and user feedback are stored (operation 1470).

In one example embodiment, a vector representation for the user interactions with explainable insights is learned using an attributed graph embedding (operation 1508); a notification to a user is triggered for verification of auto-generated constraints and the missing entities (operation 1520); and retraining of (e.g., domain-specific) forecasting models is triggered based on a supply chain forecasting pipeline health score (operation 1528), wherein the learning the joint embedding further comprises training a twin neural network (operation 1512).

In one example embodiment, a supply chain 350 is controlled based on results of applying the machine learning models.

One or more embodiments of the invention, or elements thereof, can be implemented in the form of an apparatus including a memory and at least one processor that is coupled to the memory and operative to perform exemplary method steps. FIG. 16 depicts a computer system that may be useful in implementing one or more aspects and/or elements of the invention, also representative of a cloud computing node according to an embodiment of the present invention. Referring now to FIG. 16, cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 16, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, and external disk drive arrays, RAID systems, tape drives, and data archival storage systems, etc.

Thus, one or more embodiments can make use of software running on a general purpose computer or workstation. With reference to FIG. 16, such an implementation might employ, for example, a processor 16, a memory 28, and an input/output interface 22 to a display 24 and external device(s) 14 such as a keyboard, a pointing device, or the like. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory) 30, ROM (read only memory), a fixed memory device (for example, hard drive 34), a removable memory device (for example, diskette), a flash memory and the like. In addition, the phrase “input/output interface” as used herein, is intended to contemplate an interface to, for example, one or more mechanisms for inputting data to the processing unit (for example, mouse), and one or more mechanisms for providing results associated with the processing unit (for example, printer). The processor 16, memory 28, and input/output interface 22 can be interconnected, for example, via bus 18 as part of a data processing unit 12. Suitable interconnections, for example via bus 18, can also be provided to a network interface 20, such as a network card, which can be provided to interface with a computer network, and to a media interface, such as a diskette or CD-ROM drive, which can be provided to interface with suitable media.

Accordingly, computer software including instructions or code for performing the methodologies of the invention, as described herein, may be stored in one or more of the associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 16 coupled directly or indirectly to memory elements 28 through a system bus 18. The memory elements can include local memory employed during actual implementation of the program code, bulk storage, and cache memories 32 which provide temporary storage of at least some program code in order to reduce the number of times code must be retrieved from bulk storage during implementation.

Input/output or I/O devices (including but not limited to keyboards, displays, pointing devices, and the like) can be coupled to the system either directly or through intervening I/O controllers.

Network adapters 20 may also be coupled to the system to enable the data processing system to become coupled to other data processing systems or remote printers or storage devices through intervening private or public networks. Modems, cable modem and Ethernet cards are just a few of the currently available types of network adapters.

As used herein, including the claims, a “server” includes a physical data processing system (for example, system 12 as shown in FIG. 16) running a server program. It will be understood that such a physical server may or may not include a display and keyboard.

One or more embodiments can be at least partially implemented in the context of a cloud or virtual machine environment, although this is exemplary and non-limiting. Reference is made back to FIGS. 1-2 and accompanying text.

It should be noted that any of the methods described herein can include an additional step of providing a system comprising distinct software modules embodied on a computer readable storage medium; the modules can include, for example, any or all of the appropriate elements depicted in the block diagrams and/or described herein; by way of example and not limitation, any one, some or all of the modules/blocks and or sub-modules/sub-blocks described. The method steps can then be carried out using the distinct software modules and/or sub-modules of the system, as described above, executing on one or more hardware processors such as 16. Further, a computer program product can include a computer-readable storage medium with code adapted to be implemented to carry out one or more method steps described herein, including the provision of the system with the distinct software modules.

One example of user interface that could be employed in some cases is hypertext markup language (HTML) code served out by a server or the like, to a browser of a computing device of a user. The HTML is parsed by the browser on the user’s computing device to create a graphical user interface (GUI).

### Exemplary System and Article of Manufacture Details

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
monitoring user interactions with a supply chain system based on a tracked ontology enrichment process;
constructing an explainable reasoning graph based on the monitored user interactions and domain specific reasoning information;
learning an explainable insight of the monitored user interactions;
learning a user interaction embedding for an embedding space based on the constructed explainable reasoning graph and the explainable insight;
incorporating external data into the embedding space;
learning a joint embedding based on the user interaction embedding;
identifying missing entities and relationships for incorporation into an ontology based on the user interactions and joint embedding;
revising the ontology to incorporate the missing entities and relationships into the ontology to create a revised ontology; and
controlling a supply chain based on the revised ontology.

2. The method of claim 1, further comprising:
triggering data collection based on the identified missing entities;
generating a model health score; and
retraining a forecasting model based on the model health score.

3. The method of claim 1, further comprising:
generating an explainable demand forecasting model based on an initial version of the ontology;
generating a climate reasoning graph to aid in understanding variations of product demand concerning climatic variations using explainable machine learning models with the explainable demand forecasting model;
analyzing a user interaction with the climate reasoning graph to understand a context for analyzing product demand variations in a supply chain;
analyzing historical user interactions with the climate-reasoning graph and learning a vector representation of the user interactions with the climate-reasoning graph using attributed interaction graph derived via attributed graph representation learning that captures variations of a demand forecast and external factors from one or more external data sources;
learning a node embedding in the attributed interaction graph by analyzing different users’ interactions with the climate-reasoning graph such that the node embedding captures important entities identified in the climate-reasoning graph;
comparing the node embedding with a previously generated ontology; and
analyzing user feedback regarding the previously generated ontology and performing refinement operations for generating an enhanced version of the ontology by identifying a relevant subset of the domain ontologies, wherein the learning the joint embedding is performed by learning twin networks and wherein the identifying the missing entities and relationships further comprises perturbating a joint embedding space generated from the external data sources and the user interaction embedding.

4. The method of claim 3, further comprising generating a table of attributed interaction edges of the attributed interaction graph.

5. The method of claim 1, further comprising:
learning a correlation between the joint embedding and mapping user interactions with an external data source;
training a twin network on a set of labeled data;
using the twin network in enriching the ontology by identifying additional missing entities, constraints, or both;
analyzing the user interactions using an attributed graph embedding based encoder;
analyzing external events using a first recurrent neural network (RNN) / bidirectional encoder representation from transformer (BERT)-based transformer;
obtaining user interactions with a climate reasoning graph;
processing output of the attributed graph embedding-based encoder using a first fully-connected (FC) projection layer to generate a first embedding;
processing data from the external data sources using a second RNN / BERT-based encoder followed by a second fully-connected (FC) projection layer to generate a second embedding;
mapping one or more of the external data sources and user interactions with explainable insights into a common latent space;
identifying one or more most promising user interactions with explainable insights by performing ranking based on user feedback;
performing a local search in the latent space for a top k of the identified user interactions with explainable insights to identify the missing entities and missing constraints;
identifying a set of the external data sources that are within a neighborhood of radius r in the latent space;
identifying important entities which are missing in the ontology;
identifying constraints that are referred to in the external data sources and are to be incorporated into the ontology; and
revising the ontology to include the missing entities and missing constraints, wherein the learning the joint embedding uses a hinge loss to align the user interactions and external data sources.

6. The method of claim 1, further comprising:
optimizing a generic forecasting model based on a spatial-temporal characteristic;
periodically evaluating a performance of the optimized forecasting model in different spatial-temporal dimensions and estimating a model health score;
triggering data collection based on the model health score and a corresponding budget; and
forecasting a pipeline evaluation.

7. The method of claim 1, further comprising:
receiving a natural language query as an input to analyze an impact of climatic variations using explainable insights;
identifying one or more additional entities and relationships with constraints by parsing the natural language query;
issuing one or more questions to understand a user’s query based on auto-generated explainable insights and curated knowledge in a form of the ontology;
generating one or more explainable insights using an explainable model based on the identified constraints; and
storing the generated explainable insights and user feedback.

8. The method of claim 1, further comprising:
learning a vector representation for the user interactions with explainable insights using an attributed graph embedding;
triggering a notification to a user for verification of auto-generated constraints and the missing entities; and
triggering retraining of forecasting models based on a supply chain forecasting pipeline health score, wherein the learning the joint embedding further comprises training a twin neural network.

9. The method of claim 1, wherein controlling the supply chain comprises taking at least one physical action with respect to the supply chain.

10. An apparatus comprising:
a memory; and
at least one processor, coupled to said memory, and operative to perform operations comprising:
monitoring user interactions with a supply chain system based on a tracked ontology enrichment process;
constructing an explainable reasoning graph based on the monitored user interactions and domain specific reasoning information;
learning an explainable insight of the monitored user interactions;
learning a user interaction embedding for an embedding space based on the constructed explainable reasoning graph and the explainable insight;
incorporating external data into the embedding space;
learning a joint embedding based on the user interaction embedding;
identifying missing entities and relationships for incorporation into an ontology based on the user interactions and joint embedding;
revising the ontology to incorporate the missing entities and relationships into the ontology to create a revised ontology; and
controlling a supply chain based on the revised ontology.

11. The apparatus of claim 10, the operations further comprising:
triggering data collection based on the identified missing entities;
generating a model health score; and
retraining a forecasting model based on the model health score.

12. The apparatus of claim 10, the operations further comprising:
generating an explainable demand forecasting model based on an initial version of the ontology;
generating a climate reasoning graph to aid in understanding variations of product demand concerning climatic variations using explainable machine learning models with the explainable demand forecasting model;
analyzing a user interaction with the climate reasoning graph to understand a context for analyzing product demand variations in a supply chain;
analyzing historical user interactions with the climate-reasoning graph and learning a vector representation of the user interactions with the climate-reasoning graph using attributed interaction graph derived via attributed graph representation learning that captures variations of a demand forecast and external factors from one or more external data sources;
learning a node embedding in the attributed interaction graph by analyzing different users’ interactions with the climate-reasoning graph such that the node embedding captures important entities identified in the climate-reasoning graph;
comparing the node embedding with a previously generated ontology; and
analyzing user feedback regarding the previously generated ontology and performing refinement operations for generating an enhanced version of the ontology by identifying a relevant subset of the domain ontologies, wherein the learning the joint embedding is performed by learning twin networks and wherein the identifying the missing entities and relationships further comprises perturbating a joint embedding space generated from the external data sources and the user interaction embedding.

13. The apparatus of claim 12, the operations further comprising generating a table of attributed interaction edges of the attributed interaction graph.

14. The apparatus of claim 10, the operations further comprising:
learning a correlation between the joint embedding and mapping user interactions with an external data source;
training a twin network on a set of labeled data;
using the twin network in enriching the ontology by identifying additional missing entities, constraints, or both;
analyzing the user interactions using an attributed graph embedding based encoder;
analyzing external events using a first recurrent neural network (RNN) / bidirectional encoder representation from transformer (BERT)-based transformer;
obtaining user interactions with a climate reasoning graph;
processing output of the attributed graph embedding-based encoder using a first fully-connected (FC) projection layer to generate a first embedding;
processing data from the external data sources using a second RNN / BERT-based encoder followed by a second fully-connected (FC) projection layer to generate a second embedding;
mapping one or more of the external data sources and user interactions with explainable insights into a common latent space;
identifying one or more most promising user interactions with explainable insights by performing ranking based on user feedback;
performing a local search in the latent space for a top k of the identified user interactions with explainable insights to identify the missing entities and missing constraints;
identifying a set of the external data sources that are within a neighborhood of radius r in the latent space;
identifying important entities which are missing in the ontology;
identifying constraints that are referred to in the external data sources and are to be incorporated into the ontology; and
revising the ontology to include the missing entities and missing constraints, wherein the learning the joint embedding uses a hinge loss to align the user interactions and external data sources.

15. The apparatus of claim 10, the operations further comprising:
optimizing a generic forecasting model based on a spatial-temporal characteristic;
periodically evaluating a performance of the optimized forecasting model in different spatial-temporal dimensions and estimating a model health score;
triggering data collection based on the model health score and a corresponding budget; and
forecasting a pipeline evaluation.

16. The apparatus of claim 10, the operations further comprising:
receiving a natural language query as an input to analyze an impact of climatic variations using explainable insights;
identifying one or more additional entities and relationships with constraints by parsing the natural language query;
issuing one or more questions to understand a user’s query based on auto-generated explainable insights and curated knowledge in a form of the ontology;
generating one or more explainable insights using an explainable model based on the identified constraints; and
storing the generated explainable insights and user feedback.

17. The apparatus of claim 10, the operations further comprising:
learning a vector representation for the user interactions with explainable insights using an attributed graph embedding;
triggering a notification to a user for verification of auto-generated constraints and the missing entities; and
triggering retraining of forecasting models based on a supply chain forecasting pipeline health score, wherein the learning the joint embedding further comprises training a twin neural network.

18. The method of claim 10, wherein controlling the supply chain comprises the at least one processor facilitating taking at least one physical action with respect to the supply chain.

19. A computer program product, the computer program product comprising a computer readable storage medium having program instructions embodied therewith, the program instructions executable by a computer to cause the computer to perform operations comprising:
monitoring user interactions with a supply chain system based on a tracked ontology enrichment process;
constructing an explainable reasoning graph based on the monitored user interactions and domain specific reasoning information;
learning an explainable insight of the monitored user interactions;
learning a user interaction embedding for an embedding space based on the constructed explainable reasoning graph and the explainable insight;
incorporating external data into the embedding space;
learning a joint embedding based on the user interaction embedding;
identifying missing entities and relationships for incorporation into an ontology based on the user interactions and joint embedding;
revising the ontology to incorporate the missing entities and relationships into the ontology to create a revised ontology; and
controlling a supply chain based on the revised ontology.

20. The computer program product of claim 19, wherein the operations further comprise:
triggering data collection based on the identified missing entities;
generating a model health score; and
retraining a forecasting model based on the model health score.
